(19) United States
(12) Patent Application Publication
(10) Pub. No.: US 2006/0283610 A1
(43) Pub. Date: Dec. 21, 2006

(54) Sub-soiler

(75) Inventors: Mitsuya Sugano, Inashiki-gun (JP); Kazuharu Imai, Inashiki-gun (JP); Tsuyoshi Shimomura, Inashiki-gun (JP); Masayuki Murata, Sorachi-gun (JP); Hideki Ishigaki, Chitose-shi (JP); Ryuji Tanaka, Inashiki-gun (JP); Tetsuya Saito, Inashiki-gun (JP); Takaharu Kozaki, Inashiki-gun (JP)

Correspondence Address: Joseph P. Farrar, 2-4-6 Tsukuda 709, Chuo-ku, Tokyo, 104-0051, JP

(73) Assignee: Sugano Farm Machinery Mfg. Co., Ltd., Inashiki-gun (JP)

(21) Appl. No.: 11/439,285

(22) Filed: May 24, 2006

(30) Foreign Application Priority Data
May 25, 2005 (JP) 2005-152672
Aug. 2, 2005 (JP) 2005-223835
Aug. 12, 2005 (JP) 2005-233973
Oct. 12, 2005 (JP) 2005-297338
Oct. 25, 2005 (JP) 2005-309338
Oct. 26, 2005 (JP) 2005-310891
Dec. 6, 2005 (JP) 2005-351944

(51) Int. Cl. A01B 39/20

(52) U.S. Cl. 172/730

(57) ABSTRACT

A sub-soiler has a plow bottom for subsoil for opening a furrow in a subsoil layer and raising subsoil so as to discharge the subsoil on the surface on one or both sides of the furrow and a plow bottom for top soil, located on the subsoil discharge side posterior to the plow bottom for subsoil, for breaking a top soil layer and dispersing subsoil clods discharged on the surface by the plow bottom for subsoil. Permeability of the soil at the furrow opened in the subsoil layer is improved by dispersing clods of the discharged subsoil and breaking up the top soil.

### BACKGROUND OF THE INVENTION

1. Field of the Invention

The present invention relates to a sub-soiler for carrying out a first plowing operation using a plow bottom to uproot stumps and weeds in a field during fall plowing after harvesting or the like, and more particularly, to a power tiller that is capable of simultaneously carrying out the three operations of furrowing the subsoil (as in JP-A-H08-162435), plowing, and harrowing, such simultaneous operation being more effective than carrying out these operations separately.

2. Background of the Invention

Rough plowing, also called first plowing, is the first stage in preparing the soil for crop cultivation, and generally refers to plowing carried out after crop harvest in the fall before the onset of winter. It is often referred to as fall plowing.

The purpose of the first plowing is to break the soil into approximately fist-sized clods and make the whole field loose, soft and dry. Since the first plowing allows larger voids among clods, permeability and drainage are improved. Air reaches deep into the soil and organic decomposition can be expedited by the growth of large numbers of microorganisms, so that the amount of nutrients available at the next harvesting can be increased. Accordingly, it is preferable that tillage be as deep as possible, so that the deep soil also has favorable conditions for microorganism growth.

In general, a sub-soiler (FIG. 10-2) is used in order to improve the permeability and drainage of the soil. A sub-soiler breaks up the subsoil by pulling upward while digging 30 centimeters or more into the ground. Specifically, the sub-soiler uses a knife-shaped sub-soiler beam 95 inserted into the ground and pulled upward so as to push the soil aside and separate it, while a chisel portion at the tip of the beam 95 breaks up a hard pan and the subsoil layer to improve the permeability of the soil (FIG. 10-1; JP-A-H08-162435).

A plow bottom 90 for furrowing the subsoil needs less pulling force than the sub-soiler beam 95 and therefore even a small-sized tractor can be used therewith, thus improving fuel efficiency.

In order to facilitate an understanding of the conventional art and later of the operation and effects of the present invention, a brief description is now given of the typical soil structure used in the cultivation of crops and of the equipment used to prepare the soil for cultivation.

From the top down, the typical soil structure consists of a layer of topsoil, beneath which there is the hard pan, below which there is the subsoil.

The top soil (soil) is generally soil for growing crops, and is a soil layer that is suitable for vegetation by weathering at the top layer of the ground.

The hard pan is a layer of soil so hard that it is virtually impermeable to water, and is created by compaction due to the pressure of repeated passages of heavy equipment over the soil and the downward pressure exerted by the rotation of rotary tines (reference numeral 99 in FIG. 13) on a lower layer of the top soil. The hard pan not only degrades the permeability of the soil but also can stop the root growth of the crops, causing replant failure and leading to the collapse of crops that are unable to put down deep roots (that is, a shallow rhizosphere).

The organic and inorganic micronutrients of the top soil are either fully or almost fully depleted at each successive harvest, and cannot be completely restored even with the addition of chemical fertilizers consisting chiefly of nitrogen, phosphorous, potassium and the like. However, the subsoil, although dense, insufficiently weathered and lacking in organic micronutrients, does retain inorganic micronutrients native to the soil that remain untapped by cultivation. Therefore, it can be expected that mixing the subsoil with the top soil will have the effect of supplying the micronutrients missing from the top soil, thereby improving the fertility of the soil.

Accordingly, a bottom plow is a machine that exerts a pull to carry out plowing and turning, and serves to bring a lower portion of the top soil to the surface by the bottom plow as well as to turn fertilizer and weeds on the soil surface into the lower portion of the top soil layer to improve the fertility of the soil.

Similarly, a disk plow is attached so as to provide an angle of inclination and a disk angle to a circular disk 98 (FIG. 12), to achieve the effects of harrowing and of plowing and turning. Although the action of the disk is inferior in churning performance to that of the bottom plow, the disk plow provides such capabilities as the following:

1. Cutting roots and crop residue by rotation of a thin-bladed circular disk (coulters);

2. easily cutting hard soil;

3. having the ability to carry out turning of sticky soil;

4. not easily forming a hard pan; and

5. not easily broken by obstructions such as tree roots and stones because the coulters rotate.

In addition, a rotary 99 (FIG. 13) is a machine with 10-20 rotary tines attached to a horizontal shaft that tills while rotating the tines at 150 to 300 rpm, and serves to till and harrow more shallowly and finely than the plows used to form the rhizosphere.

FIGS. 2, 4 and 6 show detailed sectional views of a typical soil structure. In FIGS. 2, 4, and 6, the upper soil for growing crops is referred to as the top soil. The soil under a top soil layer a is referred to as the subsoil. A hard pan k is generated between the top soil layer a and a subsoil layer b, and as described above is often harder than the subsoil. Therefore, soil permeability deteriorates, resulting in crops susceptible to wet rot and heavily dependant on the weather due to their shallow rhizosphere.

FIGS. 10-1 and 10-2 are perspective views of a plow bottom for furrow opening in subsoil and a sub-soiler beam.

A machine equipped with the plow bottom 90 for opening furrows in the subsoil as in FIG. 10-1 is also referred to as a sub-soiler. The plow bottom 90 has a moldboard 92 attached to the front of a beam, and constructed so that soil dug up by a gad-like chisel 91 is moved (slid) upward along the moldboard 92 and discharged at the surface.

When the plow bottom 90 for furrow opening in subsoil in FIG. 10-1 is used, a furrow g like that shown in FIG. 11-1 is formed and a portion of the top soil falls into the furrow g immediately thereafter. However, the opened furrow g also has a lot of voids formed by natural deposition. Therefore, the opened furrow g is gradually occluded from above by the pressure of the soil, and over time an upper portion of the opened furrow g is completely occluded as shown in FIG. 11-2, even when the top soil layer a is tilled using a plow, a rotary, or the like. In the case of furrows opening during fall plowing, furrow occlusion is further continued so that the opened furrow g disappears completely by the time of crop cultivation in spring.

The technique of first plowing, which raises the subsoil and deposits it on the surface of the soil while breaking up the hard pan as shown in FIG. 11-1, is in principal a good one that improves permeability for substantial periods of time. However, the subsoil, although it retains inorganic micronutrients that are not absorbed by previous harvests, is dense, insufficiently weathered and lacking in organic micronutrients as noted above, and for these reasons the deposition of large amounts of discharged subsoil h onto the surface can adversely affect the initial growth of crops and cause crop yields to decline. This is one reason why moving the top soil and leveling the land to prepare fields for cultivation results in lower crop yields for years afterward, if the subsoil is exposed when the top soil is moved.

Accordingly, in the case of the conventional plow bottom 90 for furrow opening in subsoil as shown in FIG. 10-1, a target volume of subsoil deposition on the soil surface amounting to 6-8 percent of the total amount of top soil per plowed width is preferred. This target volume is achieved by adjusting the depth for furrow opening in subsoil or by limiting the number of plow bottoms 90 for furrow opening in subsoil, so as to prevent more than the necessary amount of subsoil from being discharged onto the surface.

However, although this adjustment is easy to make in the case of upland field cultivation, when this work is carried out in paddy fields the water does not collect easily, and when it does collect, the ground softens to such an extent that tractors get stuck, rice transplanters settle and it is generally impossible to carry on with cultivation. Accordingly, a sub-soiler-type machine like that described in JP-A-2002-156677, JP-A-2002-156678 and JP-A-2002-156679 that is able to keep a constant plowing depth is used.

The method employed by the above-described sub-soiler-type machine allows soil improvement by not breaking up the hard pan but by slicing off only an upper portion of the hard pan and mixing the sliced portion with the top soil. In this method, plowing can be carried out almost stably. However, when a rear cage roller 97 like that shown in FIG. 14 runs over a large clod that is sometimes generated during such plowing, a certain plow bottom is lifted as shown in FIG. 14, a torsion angle θ is formed between a tractor and the plow bottoms of the machine, the plowing depth of one of the plowing bottoms is decreased, and it becomes impossible to maintain a constant depth overall.

The manner in which furrows are formed in the subsoil, how they are maintained, and how they are allowed to fill up or occlude, affects soil permeability and retention, soil fertility, and ultimately crop yields.

The water control requirements for a cultivated field include enough permeability to allow water to instantaneously escape underground when it rains heavily as well as sufficient water retention to soak up water in the ground by capillary action during a drought. Both abilities are disturbed by the presence of hard pans k shown in FIGS. 2, 4, and 6.

In the case of the plow bottom 90 for furrow opening in subsoil as shown in FIG. 10-1, immediately after passage of the plow bottom, an opened furrow g formed through a hard pan k as shown in FIG. 11-1 is steady, the periphery of the opened furrow g is loose and soft, and permeability and water retention are secured.

However, as noted above, over time a portion of the top soil falls in the opened furrow g while the opened furrow g itself has a lot of voids as shown in FIG. 11-1, and gradually the opened furrow g is completely occluded by the time tillage of the top soil layer is carried out.

The ultimate causes of such opened furrow g occlusion are the pressure generated by the soil itself, which is 1 ton or more per square meter, and clogging due to the flow of water.

Depending on the properties of the soil, an opened furrow g of a subsoil layer b that is left empty can be occluded in few days. However, filling the opened furrow g with chaff has confirmed that the permeability and drainage last as long as the chaff does not decay and disappear (20 years in a real example) although the opened furrow g does become narrower. Similarly, permeability and drainage is retained over a prolonged period when the subsoil layer b is filled with a foreign top soil.

When opened furrow occlusion proceeds slowly, top soil including large amounts of nutrients and large numbers of microorganisms works on the adjacent subsoil for that much longer a time to promote subsoil improvement. When opened furrow occlusion proceeds quickly, the opened furrow g is surrounded by subsoil that is poor in nutrients as shown in FIG. 11-2, and thus subsoil improvement does not progress and permeability and drainage deteriorate.

In addition, when the top soil layer a is tilled as shown in FIG. 11-2 using another machine such as a plow or the rotary 99, a new hard pan is generated as shown in FIG. 13, again debilitating the permeability of the soil and also blocking the flow of air together with that of water.

Consequently, it is preferable that the opened furrow g be filled with top soil before the start of occlusion by the subsoil so as to slow the occlusion of the furrow as much as possible, not least because the top soil with which the opened furrow g is filled is soil that gives nutrients to the subsoil layer to improve the subsoil, and has a marked effect on expanding (deepening) the crop rhizosphere, which is desirable.

In addition, in the state shown in FIG. 11-1, weathering requires time since subsoil that is usually poor in nutrients is simply dumped on the surface. Moreover, even when the dumped subsoil includes outflow fertilized soil or micronutrients that are native to the soil, uneven crop yields result unless the subsoil is evenly mixed with the top soil.

Consequently, the rotary machine in FIG. 13 is used to carry out tillage operation as shown in FIG. 11-2 in order to mix the discharged subsoil h on the surface into the top soil layer a. However, a new hard pan is generated at the top of the opened furrow g at this point as described above, again degrading the permeability and drainage of the soil and blocking the flow of water and air.

When the machine 90 for first plowing in FIG. 10-1 is used to till a field repeatedly, both the permeability and the water retention of the soil can be improved. However, when there is concern that a lot of subsoil that is poor in nutrients is dumped on the surface in a short period of time as described above, the number of plow bottoms is reduced accordingly, resulting in only limited tillage.

In addition, uneven crop yields arise between places where much discharged subsoil is included in the top soil layer and places where little discharged subsoil is included in the top soil layer.

That is, the first plowing is more effective when carried out in such a way that the opened furrow g is filled with a lot of top soil to slow opened furrow occlusion as much as possible, and further, subsoil is mixed into the top soil and not left as is on the soil surface. Further, if a lot of subsoil is not displaced onto the surface in a short period of time and the field is tilled in such a way that the position of the furrow is shifted every year, the hard pan k is eliminated after a few years, large quantities of top soil fill in the subsoil layer b while the subsoil layer b is also filled with the top soil, thus expanding (deepening) the rhizosphere.

### SUMMARY OF THE INVENTION

The present invention is directed to a sub-soiler that fills an opened furrow g with more top soil to slow opened furrow occlusion and thus promote subsoil improvement without forming a new hard pan k, and further mixes top soil and subsoil so that the subsoil is not left as is on the surface.

In addition, in the case of a paddy field, the present invention is directed to provide a sub-soiler that cuts an upper portion of a hard pan by stabilizing a plow sole correctly, promotes outflow of fertilized soil and reduction of micronutrients, and has a correct and stable depth control function for expanding a top soil layer and carrying out soil improvement.

One aspect of the present invention is a sub-soiler comprising a plow bottom for subsoil for opening a furrow in a subsoil layer and raising subsoil so as to discharge the subsoil on the surface on one or both sides of the furrow, and a plow bottom for top soil, located on the subsoil discharge side posterior to the plow bottom for subsoil, for breaking a top soil layer and dispersing subsoil clods discharged on the surface by the plow bottom for subsoil, wherein permeability to the furrow opened in the subsoil layer is improved by dispersing clods of the discharged subsoil and breaking up the top soil.

Another aspect of the present invention is a sub-soiler comprising a plow bottom for furrow opening in subsoil for opening a furrow in a subsoil layer and raising subsoil so as to discharge the subsoil on the surface on one or both sides of the furrow, and a wing attached to a rear middle portion of the plow bottom for furrow opening in subsoil that cuts and loosens an area of a boundary between a top soil layer and the subsoil layer is loosened and softened so as to make top soil fall into the opened furrow, wherein the subsoil layer is improved by opening the furrow and making the top soil fall into the opened furrow so as to fill the opened furrow with the top soil.

Preferably, a wing extension is attached posterior to the wing for plowing and turning the top soil, wherein the extension mixes the subsoil discharged on the surface into the top soil layer by making the top soil fall into the opened furrow and fill the opened furrow with the topsoil, and plowing and turning the loosened and softened rhizosphere top soil.

Another and further aspect of the present invention is a power tiller comprising a plow bottom for furrow opening in subsoil for opening a furrow in a subsoil layer and raising subsoil to discharge the subsoil on the surface, and a row of disk plows located posterior to the plow bottom for furrow opening in subsoil, for plowing a top soil layer and mixing into the top soil layer subsoil clods discharged on the surface by the plow bottom for furrow opening in subsoil, wherein plowing for turning, mixing, and harrowing of the subsoil clods and top soil are carried out as the plow bottom for furrow opening digs in so as to prevent the row of disk plows from being lifted and thick top soil in a subsoil portion is developed by mixing top soil for furrow opening into the subsoil.

of the present invention is a power tiller pulled by a vehicle, comprising a plurality of plow bottoms including a pair of gauge wheels mounted on a frame of the tiller and beams attached posterior to the gauge wheels, wherein the gauge wheels and the beams are configured in series at least on positions of right and left tracks of rear wheels or crawler belts of the vehicle.

When sub-soilers in FIGS. 2, 4, and 6 of the present invention are used to work the soil, the hard pan is first broken. Then, as shown in FIG. 11-1, a continuous furrow is formed from a subsoil layer to the surface, and subsoil dug up is deposited on the surface. Immediately thereafter, plow bottoms 30 for top soil (FIGS. 1 and 2), wings 25 and wing extensions 26 (FIGS. 3 and 4), or coulters 45 (FIGS. 5 and 6) pass, and the subsoil h deposited on the surface is thus mixed with soil of a top soil layer a to make the top soil layer a loose and soft. Further, the plow bottoms 30 for top soil, the wings 25 and the wing extensions 26, or the coulters 45, forcibly fill the opened furrow g dug in the subsoil layer b with top soil.

The resultant soil structure cross section is as shown in FIG. 9. Even when the discharged subsoil is insufficiently weathered or includes outflow fertilized soil, the subsoil is mixed into the top soil and the effects on crops are thus mitigated to cause no evenness in yield. Further, since weathering of the subsoil mixed in the top soil is promoted, micronutrients of the subsoil are supplemented effectively.

Even when the opened furrow g is somewhat occluded by ground pressure thereafter, the opened furrow remains with the upper portion open into the top soil layer a since the opened furrow is filled with the top soil. In addition, since a new hard pan is not generated, deterioration of the permeability of the soil can be prevented, and the flow of air and water is not blocked so that microorganisms can remain active.

As a result of these actions, sufficient permeability is ensured even during seeding and crop cultivation. In addition, the opened furrow g is filled with more top soil than in the conventional case, in which a portion of top soil simply falls into the furrow, and thus the activities of microorganisms and the effects of their action on the subsoil can be further stimulated, enabling the top soil in the opened furrow g to greatly improvement the adjacent subsoil.

Accordingly, opened furrow occlusion is retarded, and as a result the subsoil in contact with the opened furrow can be improved to fertile soil before the opened furrow is surrounded by subsoil that is usually poor in nutrients.

When it rains to increase redundant water q, the redundant water q passes through the top soil layer a made loose and soft, gathers in the opened furrow g, and is effectively discharged in the subsoil layer b (see FIG. 9). This is the same phenomenon as, for example, when a well is dug, and the surrounding water collects in the well. Conversely, during dry spells, water percolating by capillary action from the opened furrow g appropriately moistens the top soil layer to provide favorable conditions for microorganisms to produce a fertile field.

When the position of the opened furrow g is shifted to a different location every year, so that a new opened furrow g is opened in a different location every year, and subsoil is supplemented with top soil, the whole field can be improved so as to become an ideal field covered with a deep top soil layer after a few years without any decrease in yield.

Other features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a bird's-eye view of a tractor with a first embodiment of the present invention attached;

FIG. 2 is a side view of the tractor with the first embodiment of the present invention attached;

FIG. 3 is a bird's-eye view of a tractor with a second embodiment of the present invention attached;

FIG. 4 is a side view of the tractor with the second embodiment of the present invention attached;

FIG. 5 is a bird's-eye view of a tractor with a third embodiment of the present invention attached;

FIG. 6 is a side view of the tractor with the third embodiment of the present invention attached;

FIG. 7 is a bird's-eye view of a tractor with a fourth embodiment of the present invention attached;

FIG. 8 is a side view of the tractor with the fourth embodiment of the present invention attached;

FIG. 9 is a cross-sectional view of a soil structure immediately after operation in the case of tillage using embodiments 1 to 3 of the present invention;

FIGS. 10-1 and 10-2 are perspective views of a plow bottom for furrow opening in subsoil and a sub-soiler beam;

FIGS. 11-1 and 11-2 are a cross-sectional view of a soil structure immediately after tillage by a conventional plow bottom for furrow opening in subsoil and a cross-sectional view of a soil structure immediately after tillage of a top soil layer by a rotary or the like after a lapse of some time;

FIG. 12 is a diagram illustrating an angle of inclination and a disk angle of a disk plow;

FIG. 13 is a diagram illustrating generation of a hard pan by rotary tillage; and

FIG. 14 is a diagram showing a cage roller that has run over a clod.

### DETAILED DESCRIPTION OF THE PREFERRED EMBODIMENTS

Preferred embodiments of the present invention will now be described in detail in accordance with the accompanying drawings.

### First Embodiment

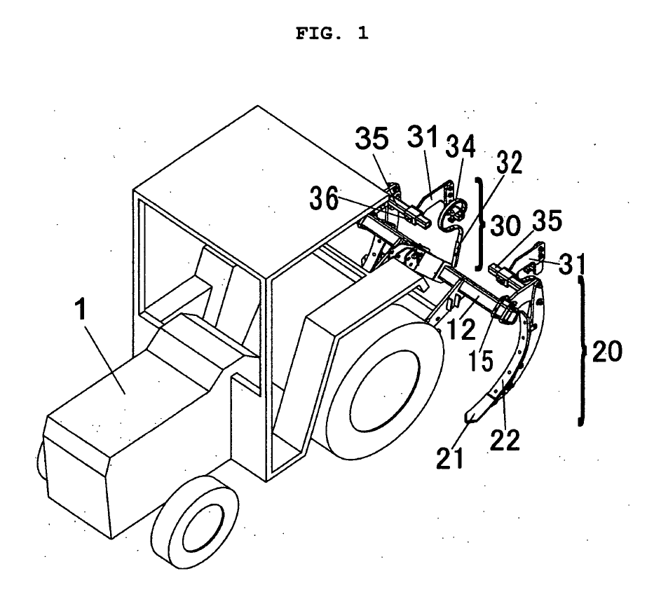

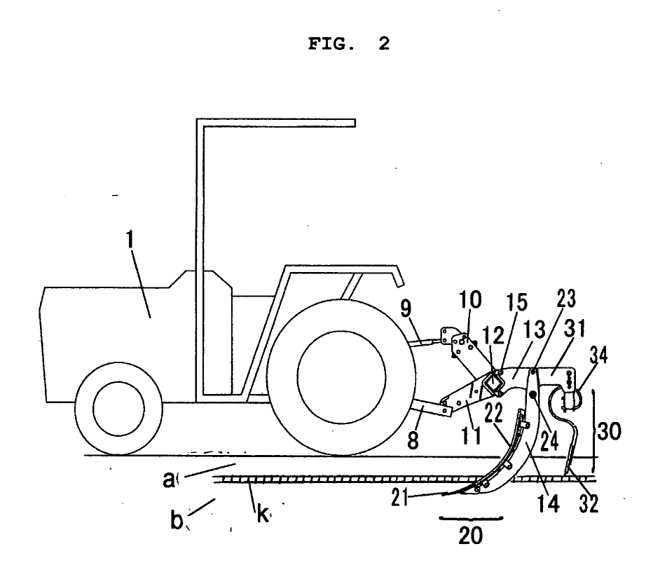

A first embodiment of the present invention is shown in FIGS. 1 and 2. The rear end of a tractor 1 has two lower links 8 and a top link 9 that are moved up and down hydraulically. With the top link 9 coupled to a mast 10 of a machine with a pin and the lower links 8 coupled to a frame 11 thereof with pins, the machine is pulled by the tractor 1 to work.

During travel along a road and turning in a headland of a field, the lower links 8 are raised high by hydraulic pressure to lift the machine so that a tillage operation can be stopped.

The mast 10 and the frame 11 are firmly fixed to an angular frame 12, and a beam plate 13 is attached to the angular frame 12 with an angular frame bolt 15 so as to be movable or removable.

A beam 14 is attached to the beam plate 13, and a chisel 21 and a moldboard 22 are attached to the bottom end and a front intermediate portion of the beam 14, respectively. This combination constitutes a plow bottom 20 for subsoil, and subsoil dug up by the chisel 21 is raised with the moldboard 22 and deposited on the surface by pulling this machine.

In this embodiment, a pair of plow bottoms 20 for subsoil is provided, and each plow bottom 20 for subsoil is formed with the moldboard 22 twisted so that subsoil clods are discharged inward.

In addition, the beam plate 13 slides on the angular frame 12 by loosening the angular frame bolt 15 so that the beam plate 13 can be fixed in an arbitrary position. This configuration allows the plow bottom 20 for subsoil to be given a width wider than the tractor width, or a narrower width by approaching the center.

The beam 14 is attached to the beam plate 13 with a main bolt 24 and a safety bolt 23. When the beam 14 hits a rock or the like to generate a force large enough to break the beam 14, the safety bolt 23 is cut and the beam 14 revolves around the main bolt 24 to deflect that force.

An angular plate 35 projects inward from the inside the beam plate 13, and the forward end of a bracket 31 is inserted into the angular plate 35 so as to be slidable. The inserted part at the forward end of the bracket 31 has a fixed bolt 36 with which the forward end is fastened and fixed in an arbitrary position.

A spring 34 is attached to the rear end of the bracket 31 with a bolt, and a point 32 is attached to the bottom end of the spring 34 so that a top soil layer a is broken as shown in FIG. 2, which form a plow bottom 30 for top soil.

In the case of the present embodiment, the plow bottom 30 for top soil is attached inside each of the pair of plow bottoms 20 for subsoil. It is to be noted that when three or more plow bottoms 30 for top soil are attached or the plow bottom 30 for topsoil is configured to discharge subsoil clods on both sides thereof, a pair of plow bottoms 30 for top soil may be attached on both sides of each plow bottom 20 for subsoil.

Although the plow bottom 30 for topsoil uses the spring 34 to deflect force in a cost reduction measure, the plow bottom 30 for top soil may be fixed to the bracket 31 by an attachment method employing a safety bolt for breakage prevention like the beam 14.

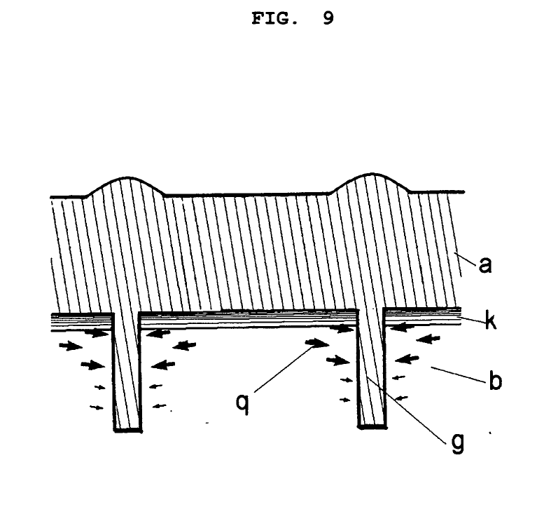

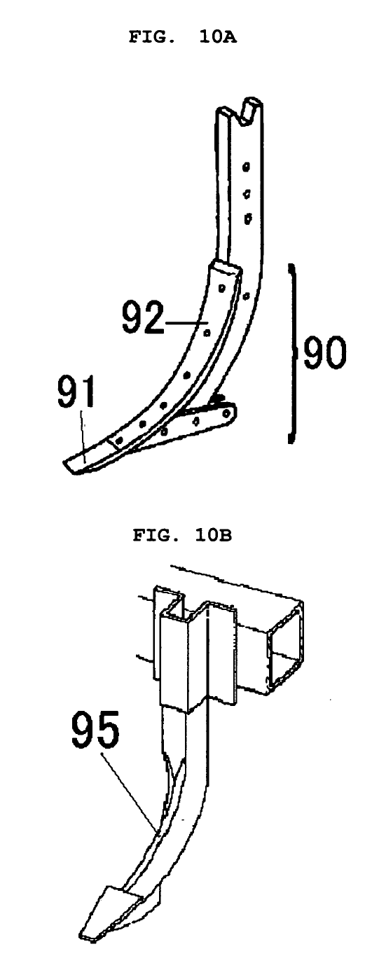

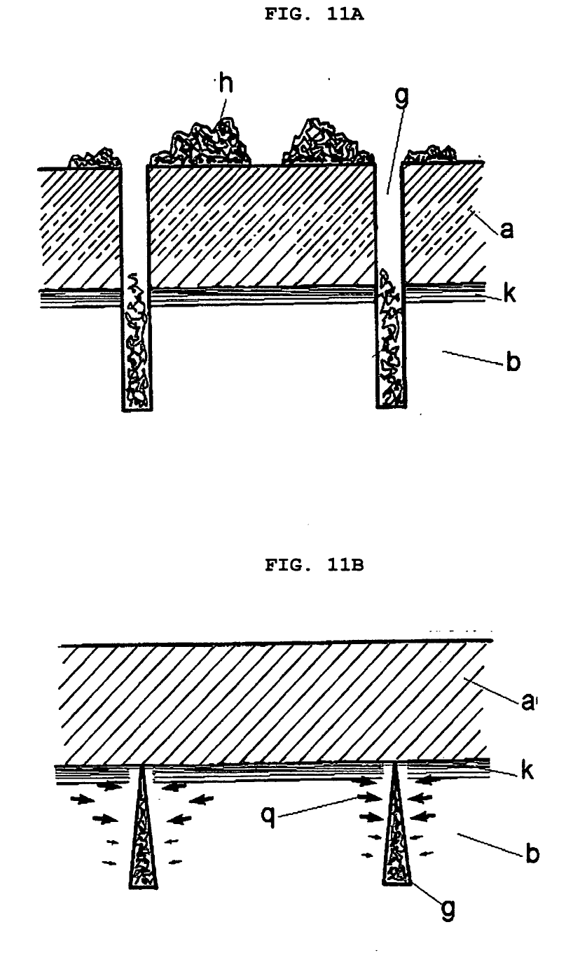

When tillage operation is carried out with the machine configured as described above, a soil structure cross section as shown in FIG. 9 is produced. Although a state as shown in FIG. 11-1 is provided immediately after passage of the plow bottoms 20 for subsoil, the plow bottoms 30 for top soil immediately pass after the passage of the plow bottom 20. Therefore, a shaded area in FIG. 9 is all made loose and soft to form a field with favorable permeability and drainage.

### Second Embodiment

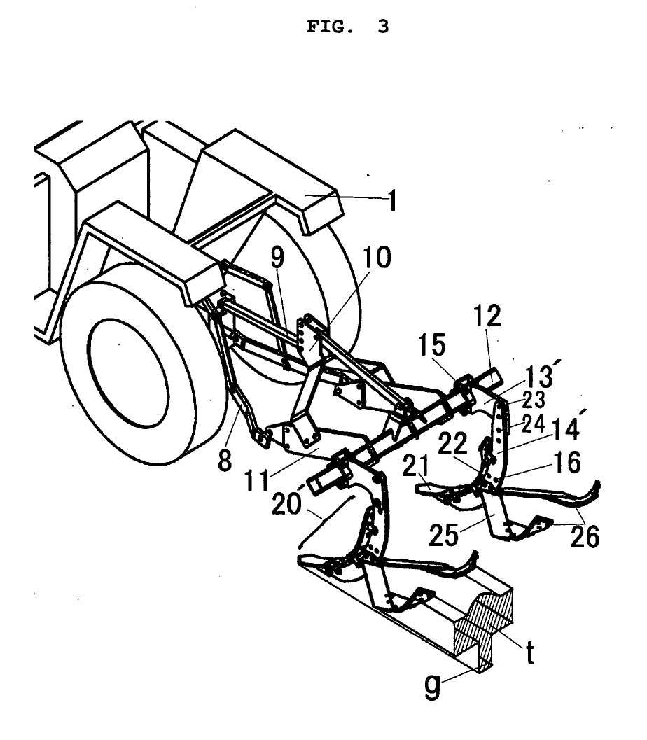

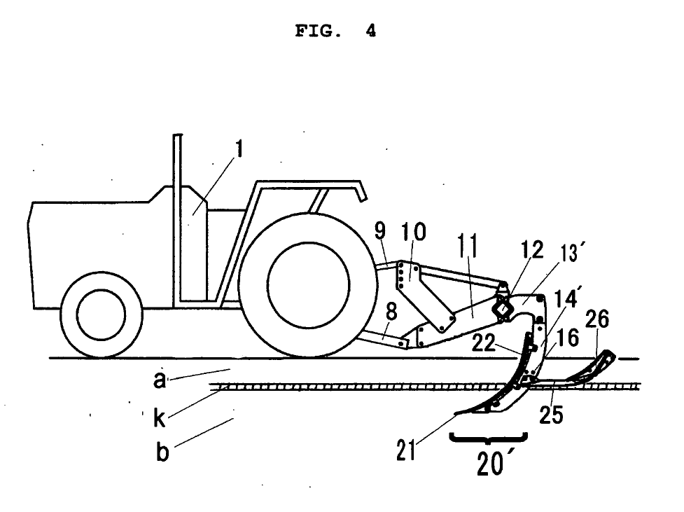

A second embodiment of the present invention is shown in FIGS. 3 and 4. In the second embodiment, the lower links 8, top link 9, mast 10, frame 11, angular frame 12, angular frame bolt 15, chisel 21, and moldboard 22 are the same as in the first embodiment. However, in the second embodiment, a beam 14′ is attached to a beam plate 13′ with a safety bolt 23 and a main bolt 24.

A wing 25 in the shape of a wing of a passenger airplane is attached to an intermediate portion of the beam 14′ of a plow bottom 20′ for subsoil, and a pair of wing extensions 26 is attached to the rear of the wing 25. The intermediate portion of the beam 14′ has a plurality of bolt holes 16 for attaching a wing so that the height and angle of wing attachment can be changed, allowing the height and angle of the wing 25 to be adjusted depending on differences in the depth of the hard pan and the properties of the soil.

The wing extensions 26 have a curved shape so as to bring top soil into an opened furrow g and to turn the soil of a top soil layer a cut and thus made loose and soft by the wing 25.

A description is given of first plowing with the machine configured as described above. Passage of the plow bottom 20′ for subsoil, the wing 15, and the wing extensions 26 shown in FIGS. 3 and 4 has a T-shaped fracture surface like a tillage cross section t shown in FIG. 3.

When the opened furrow g is dug by the plow bottom 20′ for subsoil, subsoil is slid and raised to the soil surface by the moldboard 22. In this case, the soil around the opened furrow g is also broken, the wing extensions 26 operate effectively while the wing 25 offers only slight resistance, with the result that the top soil is made to fall into the opened furrow g so as to fill in the opened furrow g.

The raised subsoil is discharged onto the soil surface, turned by the wing extensions 26, and mixed into the top soil. The center of the T-shaped tillage cross section t at the surface has, since turning is carried out by the wing extension 26 so as to bring top soil to the center, a slightly convex shape due to the turned top soil like the tillage cross section t shown in FIG. 3 and in FIG. 9, so that all of the shaded area in FIG. 9 is loosened and softened to form a field with favorable permeability and drainage.

### Third Embodiment

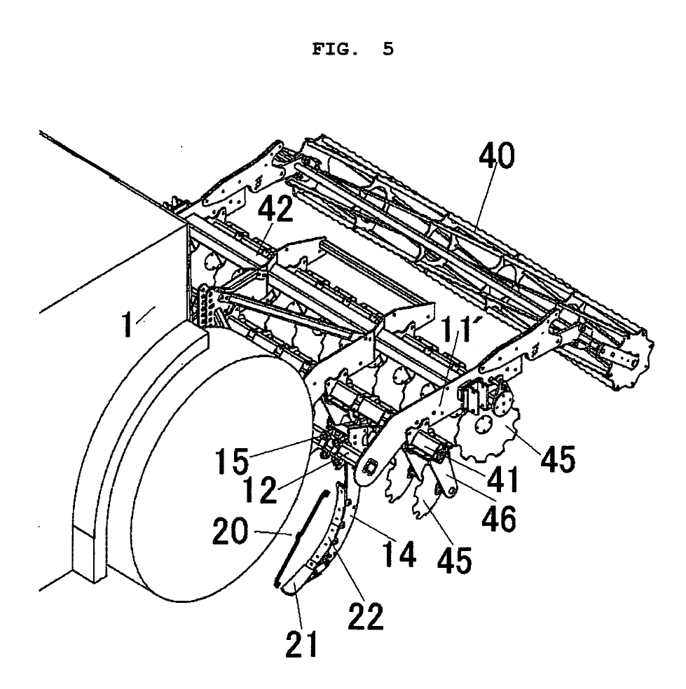

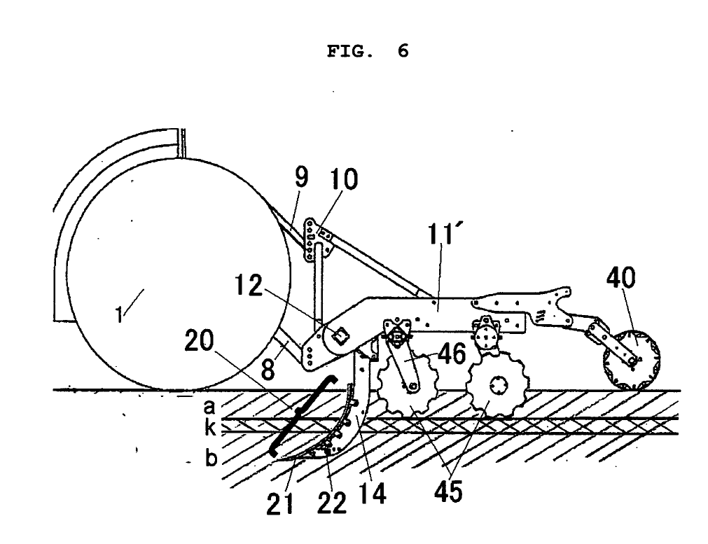

A third embodiment of the present invention is shown in FIGS. 5 and 6. In the third embodiment, the lower links 8, top link 9, mast 10, angular frame 12, angular frame bolt 15, beam 14, chisel 21, moldboard 22, and plow bottoms 20 for subsoil are the same as in the first embodiment.

In the rear of the angular frame 12, a frame 41 for right-hand turning and a frame 42 for left-hand turning are fixedly mounted on a frame 11′, with frame 41 mounted ahead of frame 42. Coulters 45 are individually attached to the frames 41 and 42 for right-hand turning and left-hand turning with disk arms 46.

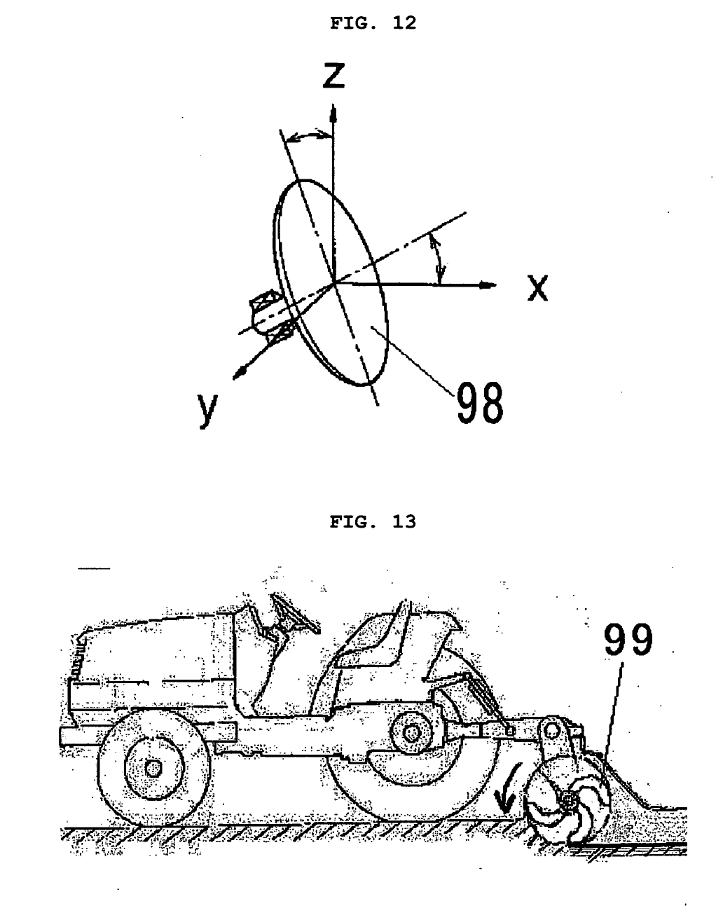

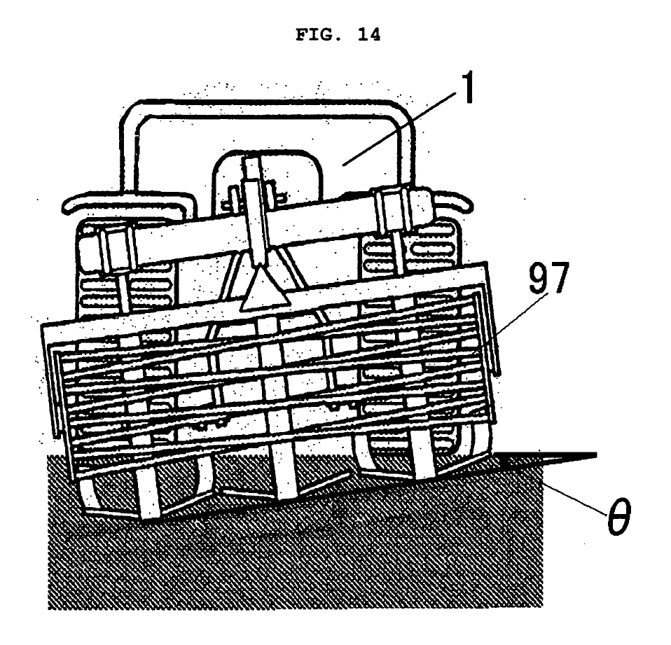

Disk angles and angles of inclination are given to the coulters 45 depending on predetermined angles of the disk arms 46 as in the case of the circular disk 98 in FIG. 12.

Individually independent disk plows in the present invention are made up of disk blades with dish-shaped curved surfaces, and the disk blades come in contact with the ground, and cut and harrow soil while rotating on their axes to provide an extraordinary effect on cutting and burying roots of weeds. The use of the coulters 45 further improves the cutting effect.

The same number of independent coulters 45 is attached to each of the frames 41 and 42 for right-hand turning and left-hand turning so that lateral reaction force is balanced.

In addition, the individually independent disk arms 46 and coulters 45 can be used to change the disk angles and angles of inclination of coulters 45 near the opened furrow g and to combine the coulters 45 for more effective filling in of the opened furrow g with top soil.

The attachment of a large number of disk plows has the drawback of being hard to dig into the ground. However, since the beam 14 provided with chisel 21 and the moldboard 22 digs deep into the ground in front of the rows of disk plows in the present application, the rows of disk plows can be prevented from being lifted. The chisel 21 and the moldboard 22 act to dig up, raise, and dump subsoil, and therefore have a pronounced effect on preventing the row of disk plows from being lifted.

A roller 40 is attached to a frame located posterior to the rows of right and left disk plows, which harrows and crushes a soil surface that has passed through the row of disk plows into smaller pieces, and finishes so as to produce a field that is almost a seeding bed.

A description is now given of plowing with the machine configured as described above.

As shown in FIG. 6, the plow bottom 20 for subsoil opens a furrow in a subsoil layer b located below a hard pan k so as to deposit subsoil on the surface. The discharged subsoil is dispersed and harrowed by the coulters 45 of the rows of right and left disk plows to be plowed and mixed into a top soil layer a. At the same time, fertilized soil such as green manure on the surface is also plowed in.

Top soil that has passed through the rows of right and left disk plows is harrowed into smaller pieces, crushed, and leveled by the roller 40, and therefore a seeding bed can be completed in one pass. In addition, the roller 40 can prevent the plow bottoms 20 for subsoil and the rows of right and left disk plows from burrowing deep into the soil.

The use of the power tiller described above allows conventional operation by a sub-soiler, plowing, and harrowing by a disk harrow to be carried out at the same time. Furthermore, the opened furrow is able to maintain permeability longer than a furrow opened by a conventional sub-soiler. In the opened furrow according to the present embodiment, an upper portion of top soil is made to fall into the opened furrow by the coulters 45. Therefore, when the position of the furrow is annually shifted slightly, the hard pan is eliminated after a few years to provide a deeper top layer, which means that the subsoil-improved effect is great.

### Fourth Embodiment

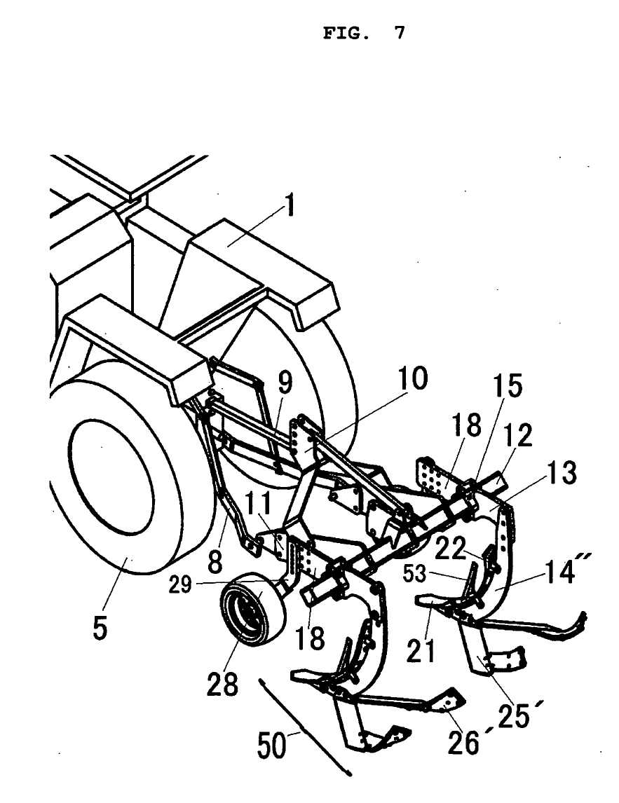

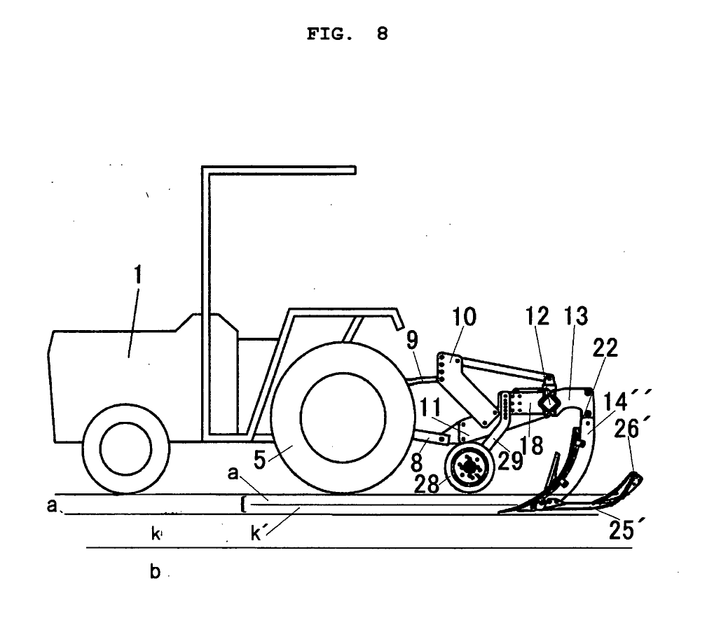

A fourth embodiment of the present invention is shown in FIGS. 7 and 8. In the fourth embodiment the lower links 8, top link 9, mast 10, frame 11, angular frame 12, angular frame bolt 15, chisel 21, and moldboard 22 are the same as in the first embodiment. A gauge wheel bracket 18 is attached to the front of a beam plate 13 of the fourth embodiment with the angular frame bolt 15, a gauge wheel plate 29 is fixed with bolts to the end of the gauge wheel bracket 18 so as to move back and forth as well as up and down, and a gauge wheel 28 is attached to the bottom end of the gauge wheel plate 29.

As its name suggests, the gauge wheel 28 is a wheel that sets a depth. The gauge wheel 28 is arranged so that a plow bottom digs in deep when the gauge wheel 28 is raised. A plurality of attachment holes is provided so that the gauge wheel 28 can be moved backward when the gauge wheel 28 is close to a tractor rear wheel 5.

A beam 14″ is attached to the rear end of the beam bracket 13, the chisel 21 and the moldboard 22 are attached to the bottom end and an intermediate portion of the beam 14″, respectively, and a knife 53 is attached to project near the center of the moldboard 22.

The above-described arrangement provides a mechanism by which soil dug up by the chisel 21 first slides along the moldboard 22 and is then dumped onto the surface while being separated into right and left sides and harrowed by the knife 53.

In the rear of the chisel 21 at the bottom end of the beam 14″, wings 25′ are attached on either side of the beam 14″ with the wings 25′ slightly inclined forward. Extensions 26′ are attached to the rear ends of the wings 25′ so that soil cut horizontally by the wings 25′ is raised, plowed, and turned aside.

The wings 25′ cut and raise soil, for example, like a share of a plow. When the pulling speed is fast, soil is splashed and harrowed to be loosened and softened. In addition, when a portion of soil is turned aside by the wing extensions 26′, other soil is also turned aside in consequence due to the viscosity of the soil.

In addition, as shown in FIGS. 7 and 8, the gauge wheel 28 and the beam 14″ including the chisel 21 are within the track width of the rear wheel 5 of the tractor, and the gauge wheel bracket 29 and the beam bracket 18 are positioned, and first plowing is carried out, so that the rear wheel 5, the gauge wheel 28, and the beam 14″ lie almost on a straight line within the track width (tire width).

The above-described configuration makes the gauge wheel 28 follow on the track width of the rear wheel 5 of the tractor to result in traveling on a portion flattened by the tread of the tractor, and thus, the gauge wheel 28 does not move up and down because of stocks or clods. Accordingly, the chisel 21 does not move up and down, and the plow sole of a plow bottom 40 is thus stable and flat so that a uniform top soil layer can be made. This allows only a layer kneaded by the tire of a tractor or the like at the top of a hard pan k, which is generally called a kneaded layer k′ and which is peculiar to paddy fields, to be cut and mixed into a top soil layer a, as shown in FIG. 8.

In the case of the first plowing machine described above, since the gauge wheel follows the track of the pulling vehicle, a prescribed amount of kneaded layer k′ can be cut stably with little vertical movement even when a field has significant unevenness. In addition, since the plow bottom 40 concentrates on the track of the pulling vehicle, first plowing can be carried out more effectively for a portion hardened due to the tractor weight.

As can be understood by one skilled in the art, the present invention can be used in both upland fields and paddy fields.

As many apparently widely different embodiments and variations of the present invention can be made without departing from the spirit and scope thereof, it is to be understood that the present invention is not limited to the specific embodiments thereof described herein but rather only to the extent set forth in the following claims.

This application claims the benefit of Japanese Patent Application Nos. 2005-152672, filed on May 25, 2005; 2005-223835, filed on Aug. 2, 2005; 2005-233973, filed on Aug. 12, 2005; 2005-297338, filed on Oct. 12, 2005; 2005-309338, filed on Oct. 25, 2005; 2005-310891, filed on Oct. 26, 2005; and 2005-351944, filed on Dec. 6, 2005, which are hereby incorporated by reference herein in their entirety.

What is claimed is:

1. A sub-soiler comprising:
a plow bottom for subsoil for opening a furrow in a subsoil layer and raising subsoil so as to discharge the subsoil on the surface on one or both sides of the furrow; and
a plow bottom for top soil, located on the subsoil discharge side posterior to the plow bottom for subsoil, for breaking a top soil layer and dispersing subsoil clods discharged on the surface by the plow bottom for subsoil,
wherein permeability to the furrow opened in the subsoil layer is improved by dispersing clods of the discharged subsoil and breaking up the top soil.

2. A sub-soiler comprising:
a plow bottom for furrow opening in subsoil for opening a furrow in a subsoil layer and raising subsoil so as to discharge the subsoil on the surface on one or both sides of the furrow; and
a wing attached to a rear middle portion of the plow bottom for furrow opening in subsoil that cuts and loosens an area of a boundary between a top soil layer and the subsoil layer is loosened and softened so as to make top soil fall into the opened furrow,
wherein the subsoil layer is improved by opening the furrow and making the top soil fall into the opened furrow so as to fill the opened furrow with the top soil.

3. The sub-soiler according to claim 2, further comprising a wing extension attached posterior to the wing for plowing and turning the top soil,
wherein the extension mixes the subsoil discharged on the surface into the top soil layer by making the top soil fall into the opened furrow and fill the opened furrow with the topsoil, and plowing and turning the loosened and softened rhizosphere top soil.

4. A power tiller comprising:
a plow bottom for furrow opening in subsoil for opening a furrow in a subsoil layer and raising subsoil to discharge the subsoil on the surface; and
a row of disk plows located posterior to the plow bottom for furrow opening in subsoil, for plowing a top soil layer and mixing into the top soil layer subsoil clods discharged on the surface by the plow bottom for furrow opening in subsoil,
wherein plowing for turning, mixing, and harrowing of the subsoil clods and top soil are carried out as the plow bottom for furrow opening digs in so as to prevent the row of disk plows from being lifted and thick top soil in a subsoil portion is developed by mixing top soil for furrow opening into the subsoil.

5. A power tiller pulled by a vehicle, comprising a plurality of plow bottoms including a pair of gauge wheels mounted on a frame of the tiller and beams attached posterior to the gauge wheels,
wherein the gauge wheels and the beams are configured in series at least on positions of right and left tracks of rear wheels or crawler belts of the vehicle.
